(19) United States
(12) Patent Application Publication
(10) Pub. No.: US 2017/0112148 A1
(43) Pub. Date: Apr. 27, 2017

(54) Dough Enrober with Side Application Belts

(71) Applicant: Burford Corporation, Maysville, OK (US)

(72) Inventors: Bob Mackey, Maysville, OK (US); Brian Risch, Norman, OK (US); Scott Clemons, Blanchard, OK (US)

(73) Assignee: Burford Corporation, Maysville, OK (US)

(21) Appl. No.: 15/331,378

(22) Filed: Oct. 21, 2016

Related U.S. Application Data
(60) Provisional application No. 62/244,631, filed on Oct. 21, 2015.

(51) Int. Cl. A21C 9/04

(52) U.S. Cl. CPC A21C 9/04

(57) ABSTRACT

A machine for depositing toppings onto a loaf of dough includes a lower belt assembly, an upper belt assembly and a pair of side belt assemblies. The lower belt assembly includes a lower conveyor belt that rotates in a first direction at a first speed to carry the loaf of dough from an upstream end of the machine to a downstream end of the machine. The upper belt assembly includes an upper conveyor belt that rotates in the first direction. Each of the pair of side belt assemblies includes a side conveyor belt positioned between the lower conveyor belt and the upper conveyor belt. At least one of the side conveyor belts includes a non-vertical portion.

### RELATED APPLICATIONS

The present application claims the benefit of U.S. Provisional Patent Application No. 62/244,631 filed Oct. 21, 2015 entitled, “Dough Enrober with Side Application Belts,” the disclosure of which is herein incorporated by reference.

### FIELD OF THE INVENTION

The present invention generally relates to equipment used in the baking industry and more particularly, but not by way of limitation, to equipment configured to apply toppings onto baked goods.

### BACKGROUND OF THE INVENTION

For many years, commercial bakeries have utilized assembly-line production to prepare and bake products. In many cases, baked goods are prepared by placing pans onto the assembly line, loading dough into the pans and moving the pans and dough through preparation, cooking and packaging processes. For some products, it is desirable to apply toppings or coatings to the dough before it is cooked. Toppings may include, for example, seeds, flour, oils and butter.

During the commercial baking process, dough is formed into loafs first by separating a large quantity of dough into smaller dough balls. The smaller dough balls are then flattened and then rolled into a relatively hollow roll. The rolled dough is then passed through a “molding” table in which the roll is compressed as it passes on a conveyor under a stationary molding table. Following the molding table, the formed dough loaf is dropped into a pan and conveyed to an oven for baking.

Recently, it has become desirable to “enrobe” toppings onto the dough loaf before the baking process takes place. In a conveyor-driven system, it is known to deposit toppings onto the conveyor behind the dough loaf before it enters the molding table. Once the dough contacts the molding table, the forward travel of the dough loaf is retarded as the dough loaf rotates between the molding table and the conveyor. The toppings deposited onto the conveyor pass under the rotating loaf and the toppings are pressed into the dough.

Although somewhat effective, the current systems for enrobing dough with toppings suffer from two significant drawbacks. First, the sides of the dough loaf are not effectively enrobed with toppings. The toppings deposited onto the horizontal conveyor are not distributed onto the substantially vertical ends of the dough loaf. Second, the molding table must be made relatively long to ensure that the dough loaf passing under the molding table revolves a sufficient number of times to allow for satisfactory deposition of toppings on the dough. It is to this and other deficiencies in the prior art that the preferred embodiments are directed.

### SUMMARY OF THE INVENTION

In one aspect, the preferred embodiments include a machine for depositing toppings onto a loaf of dough. The machine includes a lower belt assembly, an upper belt assembly and a pair of side belt assemblies. The lower belt assembly includes a lower conveyor belt that rotates in a first direction at a first speed to carry the loaf of dough from an upstream end of the machine to a downstream end of the machine. The upper belt assembly includes an upper conveyor belt that rotates in the first direction. Each of the pair of side belt assemblies includes a side conveyor belt positioned between the lower conveyor belt and the upper conveyor belt.

In another aspect, the preferred embodiments include a machine for depositing toppings onto a loaf of dough, where the machine includes a lower belt assembly, an upper belt assembly opposite the lower belt assembly and a pair of side belt assemblies. Each of the pair of side belt assemblies includes a side conveyor belt positioned between the lower conveyor belt and the upper conveyor belt and wherein at least one of the side conveyor belts includes a non-vertical portion.

In yet another aspect, the preferred embodiments include a machine for depositing toppings onto a loaf of dough, where the machine includes a topping applicator assembly, a lower belt assembly, an upper belt assembly and a pair of side belt assemblies. The lower belt assembly extends below the topping applicator assembly and the upper belt assembly is opposite the lower belt assembly. Each of the pair of side belt assemblies includes a side conveyor belt positioned between the lower conveyor belt and the upper conveyor belt.

### BRIEF DESCRIPTION OF THE DRAWINGS

FIG. 1 presents a front perspective view of a dough enrober constructed in accordance with a preferred embodiment.

FIG. 2 presents a front perspective view of the dough enrober FIG. 1 with the topping applicator assembly removed.

FIG. 3 presents a top view of the dough enrober FIG. 1 with the topping applicator assembly removed.

FIG. 4 presents a front end view of the dough enrober FIG. 1 with the topping applicator assembly removed.

FIG. 5 presents a front perspective view of the side application belt assemblies of the dough enrober of FIG. 1.

FIG. 6 presents a top view of the side application belt assemblies of the dough enrober of FIG. 1.

FIG. 7 presents a front end view of the side application belt assemblies of the dough enrober of FIG. 1.

FIG. 8 presents a front perspective view of the side application belt assemblies of the dough enrober of FIG. 1 with the belts removed.

FIG. 9 presents a front end view of the side application belt assemblies of the dough enrober of FIG. 1 with the belts removed.

FIG. 10 presents a side view of the side application belt assemblies of the dough enrober of FIG. 1 with the belts removed.

### WRITTEN DESCRIPTION

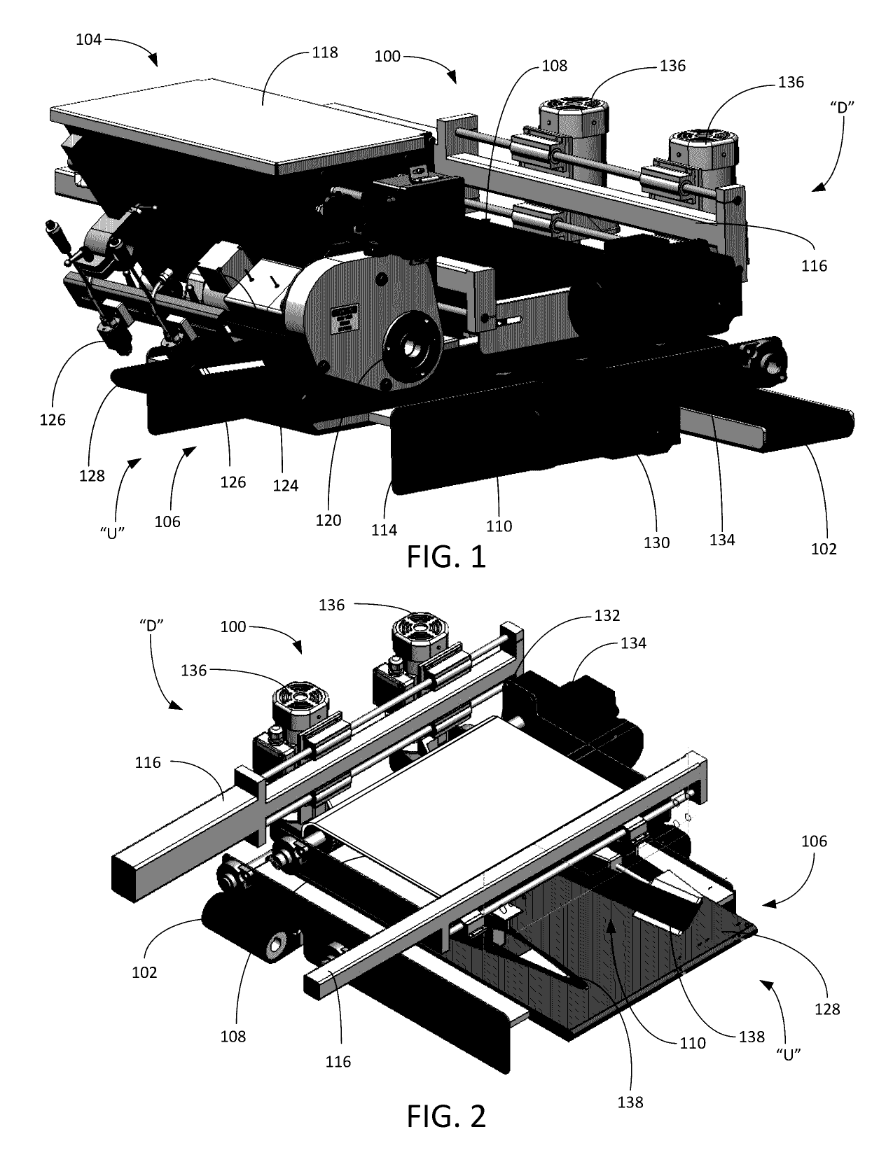

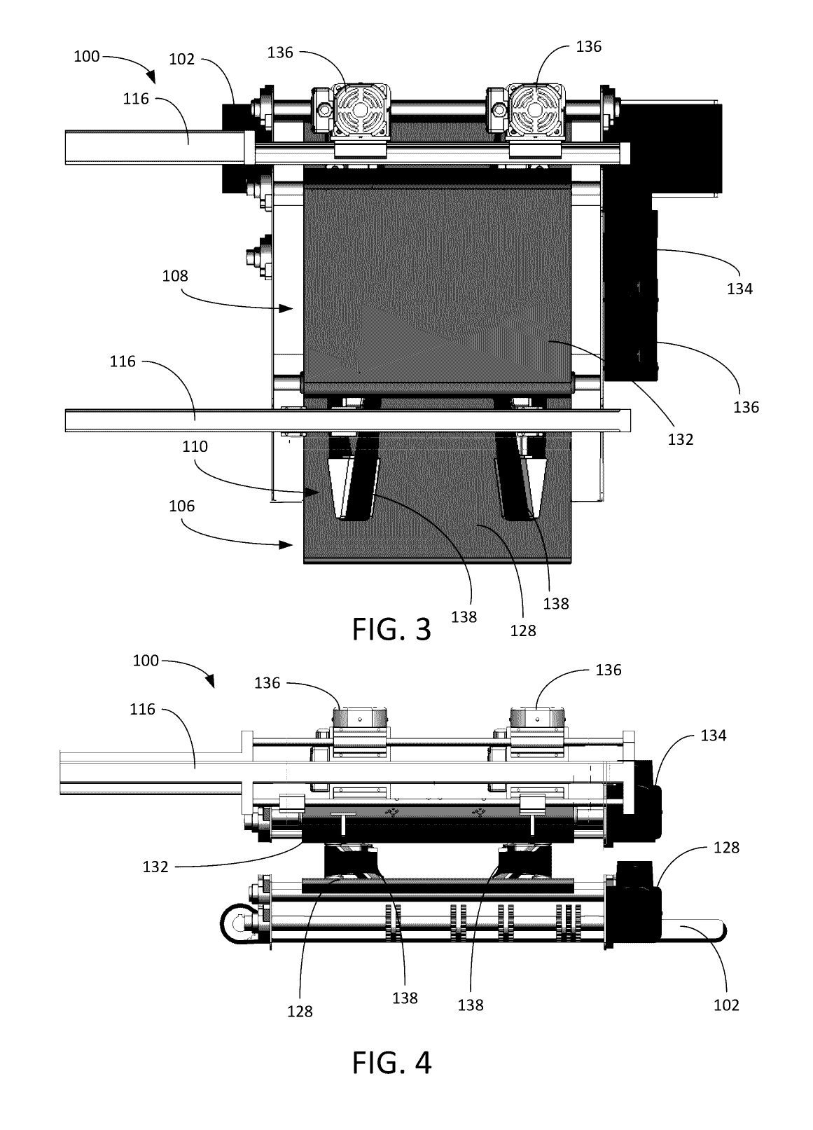

Referring to FIGS. 1-4, shown therein are front right perspective, front left perspective, top and front views, respectively, of a dough enrober 100 constructed in accordance with preferred embodiments. The dough enrober 100 is configured to be connected within a larger mechanized baking operation in which dough loafs are carried to the dough enrober 100 on a feed conveyor (not shown). As explained herein, the dough enrober 100 is configured to deposit toppings onto all sides of the dough loafs in an efficient manner. The fully enrobed dough loafs are then deposited onto a discharge conveyor (also not shown) which may include the step of depositing the enrobed dough loafs into baking pans. Scraps and excess toppings are removed from the dough enrober 100 by a scraps conveyor 102 connected to the downstream side of the dough enrober 100. For purposes of this disclosure, the dough enrober 100 will be understood to have an upstream end (“U”) and a downstream end (“D”) that are relatively defined by the motion of products through the dough enrober 100.

The dough enrober 100 includes a topping application assembly 104, a lower belt assembly 106, an upper belt assembly 108, side belt assemblies 110, an upper frame assembly 112 and a lower frame assembly 114. The lower frame assembly 114 supports the lower belt assembly 106. The upper frame assembly 112 supports the topping application assembly 104, upper belt assembly 108 and side belt assemblies 110. In a particularly preferred embodiment, the lower frame assembly 114 is supported by a table (not shown). The upper frame assembly 112 includes arms 116 that suspend the topping application assembly 104, upper belt assembly 108 and side belt assemblies 110 above the lower belt assembly 106.

The topping application assembly 104 (shown only in FIG. 1) includes a topping hopper 118, a topping distributor 120, a liquid spray assembly 122 and a position sensor 124. The position sensor 124 is configured to detect the presence of a dough loaf approaching the lower belt assembly 106 and side belt assemblies 110. The position sensor 124 outputs a signal to a control module (not shown) that activates the operation of the topping distributor 120 and liquid spray assembly 122.

The topping distributor 120 may include a rotating mandrel that selectively rotates to deposit toppings onto the lower belt assembly 106 and side belt assemblies 110. As illustrated in FIG. 1, the topping distributor preferably deposits a line of toppings in a transverse orientation to the longitudinal movement of the lower belt assembly 106 and side belt assemblies 110. Toppings are fed to the topping distributor 120 by gravity from the topping hopper 118. Toppings may include seeds, spices, sugar, fruits, or other solid particulates.

The liquid spray assembly 122 includes one or more nozzles 126 that are configured to selectively spray liquid onto the lower belt assembly 106, side belt assemblies 110 and dough loaf (not shown). The liquid spray assembly 122 can be configured to spray water, oil or other liquid-phase ingredients. In a particularly preferred embodiment, liquid spray assembly 122 is configured to spray the dough loaf and the side belt assemblies 110 before the topping distributor 120 is activated to deposit toppings.

In this way, the dough loaf and side belt assemblies 110 are wetted so that they more effectively hold the toppings subsequently released by the topping distributor 120. Thus, in particularly preferred embodiments, the dough enrober 100 detects an approaching dough loaf, activates the liquid spray assembly 122 to wet the dough and side belt assemblies 110 and then activates the topping distributor 120 to deposit toppings onto the dough loaf and side belt assemblies 110 adjacent the dough loaf and onto the lower belt assembly 106 behind the dough loaf.

The lower belt assembly 106 includes a lower conveyor belt 128 that is driven by a lower conveyor belt motor 130. The lower conveyor belt 128 carries the dough loaf through the dough enrober 100. The upper belt assembly 108 includes an upper conveyor belt 132 that is driven by an upper conveyor belt motor 134. The upper belt assembly 108 is positioned over the lower belt assembly 106 at a vertical distance that causes the dough loaf to contact the upper conveyor belt 132 as it rides on the lower conveyor belt 128. Viewed from the side, the upper belt assembly 108 and lower belt assembly 106 are configured to rotate in the same direction (either clockwise or counterclockwise depending on the viewing side). Preferably, the ratio of the speeds of the upper conveyor belt 132 to the lower conveyor belt 128 is less than 1. This configuration produces an increased rotation of the dough loaf as it passes through the enrober 100. This presents an advancement over the use of stationary molding table because the dough loaf can be made to undergo an increased number of revolutions in a shorter distance.

Furthermore, the relative speeds of the lower conveyor belt 128 and upper conveyor belt 132 can be adjusted to increase or decrease the number of revolutions that the dough loaf undergoes while passing through the dough enrober 100. This, in essence, increases or decrease the residence time of the dough loaf in the dough enrober 100, which in turn affects in a directly proportional manner the extent to which toppings are enrobed onto the dough loaf.

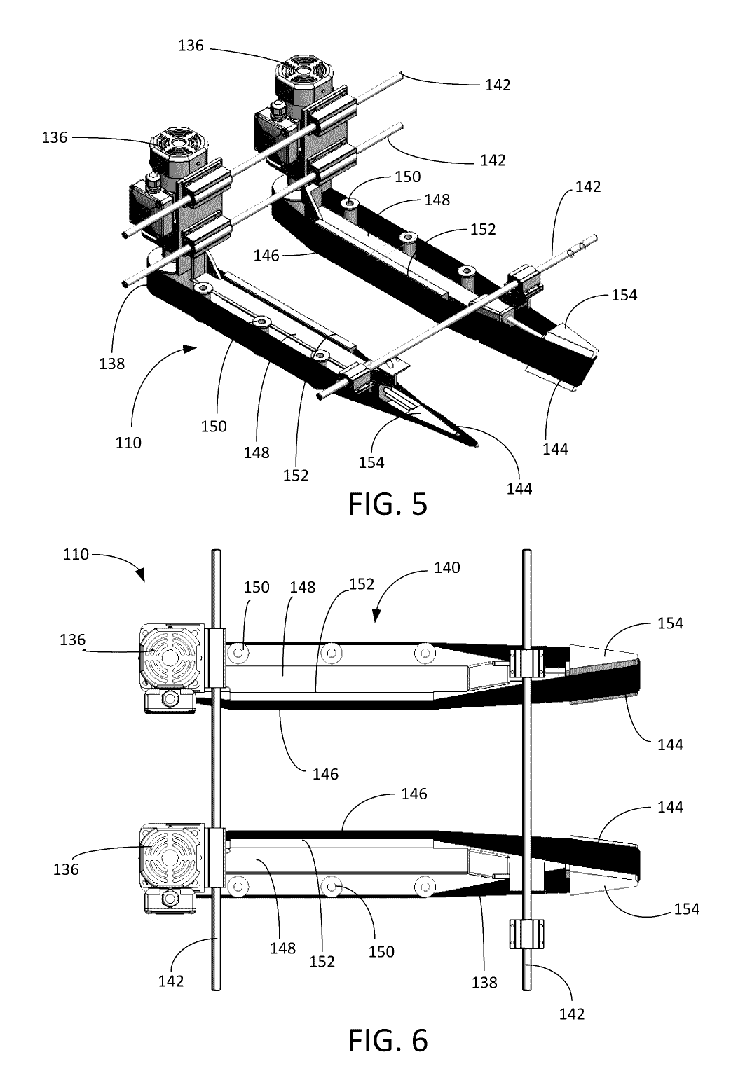

Turning to FIGS. 5-7, shown therein are perspective, top and front end views, respectively, of the side belt assemblies 110. The side belt assemblies 110 include side belt motors 136, side conveyor belts 138, belt support assemblies 140, and lateral adjustment mechanisms 142. The side belt assemblies 110 are configured to rotate in the same downstream direction as the lower belt assembly 106.

In a particularly preferred embodiment, the lower edge of each of the side conveyor belts 138 is in contact with the lower conveyor belt 128 and the rotation of each belt is automatically speed-matched to reduce wear between these belts. The lateral adjustment mechanisms 142 allow the two side belt assemblies 110 to be laterally displaced to control the distance between the two opposed side belt assemblies 110. In preferred embodiments, the distance between the two side belt assemblies 110 is selected to be only nominally smaller than the length of the dough loaf approaching the dough enrober 100.

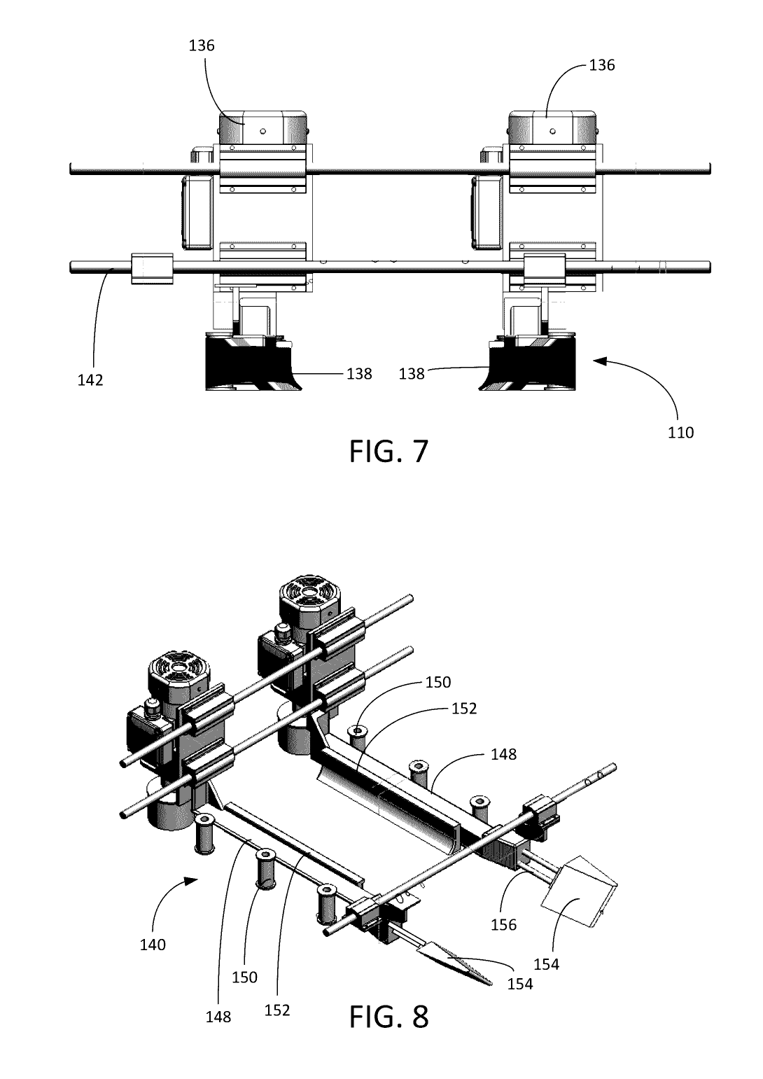

Notably, the belt support assemblies 140 are configured such that the side conveyor belts 138 include a non-vertical portion 144 that twists into a vertical side portion 146, as best seen in FIG. 6. The non-vertical portion 144 of the side conveyor belts 138 is preferably disposed below the topping distributor 120, such that dispensed toppings fall onto a relatively horizontal surface of the side conveyor belts 138. This increases the temporary adhesion of the toppings onto the side conveyor belts 138. As best illustrated in FIG. 7, the twisted side conveyor belts 138 and guides 152 create a curved profile that is designed to match the curved sides of the dough loaf. This optimizes the distribution and application of toppings on the sides of the dough loaf.

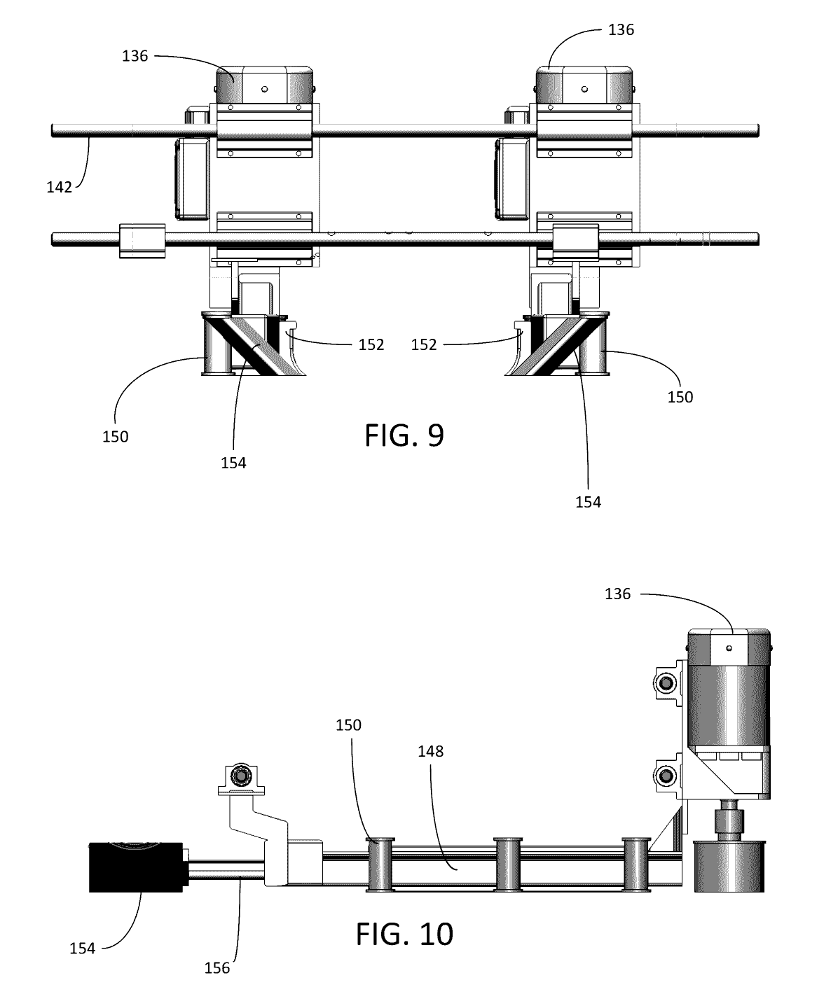

FIGS. 8-10 depict the belt support assemblies 140 with the side conveyor belts 138 removed. The belt support assemblies 140 include a body 148, rollers 150, a guide 152 and a nose piece 154. Each side conveyor belt 138 passes over the rollers 150, guide 152 and nose piece 154. The nose piece 154 is preferably an angular component that can be rotated and extended relative to the body 148 to adjust the angular position of the side conveyor belt 138. The nose piece 154 can be adjustably connected to the body 148 with control bolts 156. In a particularly preferred embodiment, the nose pieces 154 are adjusted such that the upstream ends of the side conveyor belts 138 are slightly above the lower conveyor belt 128.

During use, a dough loaf is carried into the upper belt assembly 108 and side belt assemblies 110 by the lower belt assembly 106. As the dough loaf approaches the upper belt assembly 108, the liquid spray assembly 122 sprays a selected liquid onto one or more of the following components: the dough loaf, lower conveyor belt 128 and side conveyor belts 138. The topping distributor 120 then discharges toppings onto the dough loaf, wetted side conveyor belts 138 and a swath of the lower conveyor belt 128 and side conveyor belts 138 behind the dough loaf.

Next, as partially coated dough loaf contacts the upper conveyor belt 132 and side conveyor belts 138, the dough loaf rotates backwards over the toppings deposited on the lower conveyor belt 128 and side conveyor belts 138.

Notably, the dough loaf rotates backwards with a reduced longitudinal travel velocity as the lower conveyor belt 128 and side conveyor belts 138, which are covered with toppings, pass under and around the rotating dough loaf, thereby depositing toppings to all surfaces of the dough loaf to produce a dough loaf that is completely enrobed with toppings. This presents a significant advancement over the prior art by increasing the deposition of toppings onto the dough loaf while reducing the distance required for the enrobing application.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed herein and as expressed in the appended claims. For example, alternate embodiments may include the use of a parabolic lower conveyor assembly that includes side portions that transition from the horizontal lower portion to the vertical side portions.

What is claimed is:

1. A machine for depositing toppings onto a loaf of dough, the machine comprising:
a lower belt assembly, wherein the lower belt assembly comprises a lower conveyor belt that rotates in a first direction at a first speed to carry the loaf of dough from an upstream end of the machine to a downstream end of the machine;
an upper belt assembly, wherein the upper belt assembly comprises an upper conveyor belt that rotates in the first direction; and
a pair of side belt assemblies, wherein each of the pair of side belt assemblies includes a side conveyor belt positioned between the lower conveyor belt and the upper conveyor belt.

2. The machine of claim 1, wherein the upper conveyor belt rotates at a second speed that is slower than the first speed.

3. The machine of claim 1, wherein at least one of the side conveyor belts includes a non-vertical portion.

4. The machine of claim 3, wherein each of the side conveyor belts includes a vertical portion and a non-vertical portion.

5. The machine of claim 3, further comprising a topping applicator assembly that comprises:
a topping hopper;
a topping distributor connected to the topping hopper; and
a liquid spray assembly.

6. The machine of claim 5, wherein the liquid spray assembly is configured to spray a liquid and create a wetted surface on each of the lower conveyor belt, the non-vertical portion of each of the pair of side conveyor belts and the loaf of dough as it approaches the topping distributor.

7. The machine of claim 6, wherein the topping distributor is configured to deposit toppings on the wetted surfaces of the lower conveyor belt, the non-vertical portion of each of the pair of side conveyor belts and the loaf of dough as it passes under the topping distributor.

8. The machine of claim 1, wherein each of the side conveyor belts rotates in the first direction.

9. The machine of claim 8, wherein each of the side conveyor belts rotates at a third speed that is substantially the same as the first speed.

10. The machine of claim 1, wherein the side belt assemblies further comprises:
belt support assemblies; and
a lateral adjustment mechanism, wherein the lateral adjustment mechanism is configured to control the distance between the side conveyor belts.

11. A machine for depositing toppings onto a loaf of dough, the machine comprising:
a lower belt assembly;
an upper belt assembly opposite the lower belt assembly; and
a pair of side belt assemblies, wherein each of the pair of side belt assemblies includes a side conveyor belt positioned between the lower conveyor belt and the upper conveyor belt and wherein at least one of the side conveyor belts includes a non-vertical portion.

12. The machine of claim 11, wherein each of the side conveyor belts includes a non-vertical portion.

13. The machine of claim 13, wherein each of the side conveyor belts and the lower belt assembly rotate at substantially the same speed.

14. The machine of claim 11, wherein each of the pair of side belt assemblies comprises:
a body;
a plurality of rollers;
an adjustable nose piece; and
control bolts connected between the body and the adjustable nose piece.

15. The machine of claim 14, wherein the pair of side belt assemblies comprise a lateral adjustment mechanism, wherein the lateral adjustment mechanism is configured to control the distance between the side conveyor belts.

16. A machine for depositing toppings onto a loaf of dough, the machine comprising:
a topping applicator assembly;
a lower belt assembly, wherein the lower belt assembly extends below the topping applicator assembly;
an upper belt assembly opposite the lower belt assembly; and
a pair of side belt assemblies, wherein each of the pair of side belt assemblies includes a side conveyor belt positioned between the lower conveyor belt and the upper conveyor belt.

17. The machine of claim 16, wherein each side conveyor belt includes a vertical portion and a non-vertical portion.

18. The machine of claim 17, wherein the topping applicator assembly comprises:
a topping hopper;
a topping distributor connected to the topping hopper; and
a liquid spray assembly.

19. The machine of claim 18, wherein the liquid spray assembly is configured to spray a liquid and create a wetted surface on each of the lower conveyor belt, the non-vertical portion of each of the pair of side conveyor belts and the loaf of dough as it approaches the topping distributor.

20. The machine of claim 19, wherein the topping distributor is configured to deposit toppings on the wetted surfaces of the lower conveyor belt, the non-vertical portion of each of the pair of side conveyor belts and the loaf of dough as it passes under the topping distributor.
